(19) United States
(12) Patent Application Publication
(10) Pub. No.: US 2015/0213718 A1
(43) Pub. Date: Jul. 30, 2015

(54) DRIVE SUPPORT APPARATUS

(71) Applicant: TOYOTA JIDOSHA KABUSHIKI KAISHA, Toyota-shi (JP)

(72) Inventor: Tomoya ONO, Nagoya-shi (JP)

(21) Appl. No.: 14/555,883

(22) Filed: Nov. 28, 2014

(30) Foreign Application Priority Data
Jan. 24, 2014 (JP) 2014-011681

(51) Int. Cl. G08G 1/16; B60Q 9/00; B60Q 1/00

(52) U.S. Cl. CPC G08G 1/167; B60Q 1/00; B60Q 9/008

(57) ABSTRACT

A drive support apparatus includes a rear side object detection unit to detect a relative position and speed of a rear side object relative to a vehicle having the drive support apparatus, the rear side object traveling in a lane adjacent to a traveling lane of the vehicle; a calculation unit to calculate time for the rear side object to catch up with the vehicle, based on the relative position and speed; and an alarm unit to issue an alarm to a driver of the vehicle if the time to catch up is a threshold or less. The drive support apparatus further includes a front side object detection unit to detect a front side object traveling in front in the adjacent lane; and a threshold determination unit to determine the threshold based on the front side object.

### FIELD

The disclosures herein generally relate to a drive support apparatus that supports a lane change of a vehicle.

### BACKGROUND

Conventionally, a drive support apparatus has been known that issues an alarm to a driver of a vehicle when a rear side vehicle travels on the rear side of the vehicle, and TTC (Time To Collision; time for the other vehicle to catch up with the rear end of the vehicle) becomes lower than or equal to a threshold (for example, Patent Document 1).

### RELATED-ART DOCUMENTS

### Patent Documents

[Patent Document 1] Japanese Laid-open Patent Publication No. 2009-265842

However, the drive support apparatus relating to Patent Document 1 issues an alarm only based on a relationship with the rear side vehicle. Therefore, the threshold is set fixed, which may result in cases where an alarm timing is not appropriate.

For example, if a front side vehicle exists in a destination lane, the vehicle needs to make a lane change so that it goes behind the front side vehicle. Therefore, if an alarm is issued only based on the relationship with the rear side vehicle, the alarm timing may not be appropriate.

Thereupon, in view of the above, it is an object of at least an embodiment of the present invention to provide a drive support apparatus that can issue an alarm at an appropriate timing based on TTC with a rear side vehicle that travels on the rear side of the vehicle.

### SUMMARY

According to an embodiment of the present invention, a drive support apparatus includes a rear side object detection unit configured to detect a relative position and a relative speed of a rear side object with respect to a vehicle having the drive support apparatus installed, the rear side object traveling in an adjacent lane adjacent to a traveling lane of the vehicle, and being on a rear side of the vehicle; a calculation unit configured to calculate time for the rear side object to catch up with a rear end of the vehicle in the adjacent lane, based on the relative position and the relative speed; and an alarm unit configured to issue an alarm to a driver of the vehicle if the time to catch up is less than or equal to a threshold. The drive support apparatus further includes a front side object detection unit configured to detect a front side object traveling on a front side of the vehicle in the adjacent lane; and a threshold determination unit configured to determine the threshold based on the front side object.

According to an embodiment of the present invention, it is possible to provide a drive support apparatus that can issue an alarm at an appropriate timing based on TTC with a rear side vehicle that travels on the rear side of the vehicle.

### BRIEF DESCRIPTION OF DRAWINGS

FIG. 1 is a block diagram illustrating an example of a configuration of a drive support apparatus.

FIG. 2 is a diagram illustrating an example of a method of detecting objects in an adjacent lane by a front side radar and a rear side radar.

FIG. 3 is a flowchart illustrating an example of alarm process steps executed by a drive support apparatus (ECU) for a driver.

FIG. 4 is a diagram illustrating an example of a method of determining whether there is allowance of time to accelerate a vehicle for making a lane change.

FIG. 5 is a diagram illustrating an example of an alarm execution condition map.

FIG. 6 is a flowchart illustrating an example of process steps executed by a drive support apparatus (ECU) to indicate to a driver whether a vehicle needs to accelerate for making a lane change.

FIG. 7 is a diagram illustrating an example of a method of determining whether a vehicle needs to accelerate for making a lane change.

### DESCRIPTION OF EMBODIMENTS

In the following, embodiments of the present invention will be described with reference to the drawings.

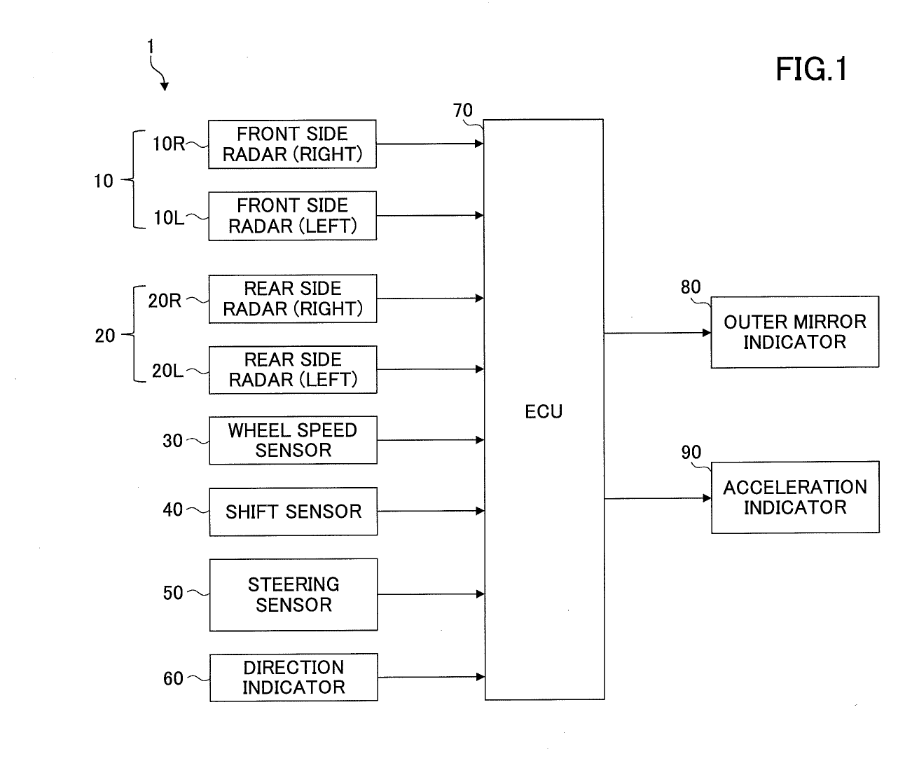

FIG. 1 is a block diagram illustrating an example of a configuration of a drive support apparatus 1.

The drive support apparatus 1 includes a front side object detection unit 10, a rear side object detection unit 20, a wheel speed sensor 30, a shift sensor 40, a steering sensor 50, a direction indicator 60, an ECU 70, an outer mirror indicator 80, and an acceleration indicator 90.

The front side object detection unit 10 includes front side radars 10L and 10R.

The front side radars 10L and 10R are object detection units to detect objects at the left front side and the right front side of the vehicle, respectively, and may be placed, for example, at positions offset to the left and right at a front end part of the vehicle (in a front bumper or a front grill). Specifically, the front side radar 10L detects an object that travels on the left front side of the vehicle in the adjacent lane (left front side vehicle), and the front side radar 10R detects an object that travels on the right front side of the vehicle in the adjacent lane (right front side vehicle). The front side radars 10L and 10R may be configured with, for example, millimeter-wave radars, transmit radio waves in a 26 GHz millimeter wave band in a predetermined detectable range, and detect objects (the left front side vehicle and/or the right front side vehicle) by receiving reflected waves. Also, based on the received reflected waves, they may detect the relative position (distance and direction) and the relative speed of the detected objects with respect to the vehicle.

The front side radars 10L and 10R are connected with the ECU 70 by an in-vehicle LAN or a direct line for communication, respectively, and output target object information (front side target object information) to the ECU 70 that includes the relative position (distance and direction) and the relative speed of the objects detected on the left front side and the right front side of the vehicle, respectively.

Note that the front side radars 10L and 10R just need to be capable of detecting objects that exist on the front side of the vehicle, and may be configured as, for example, laser radars. Also, instead of the front side radars 10L and 10R, the front side object detection unit 10 may use cameras that can capture images in front of the vehicle with a wide angle, or may include the cameras in addition to the front side radars 10L and 10R.

The rear side object detection unit 20 includes rear side radars 20L and 20R.

The rear side radars 20L and 20R are object detection units to detect objects at the left rear side and the right rear side of the vehicle, respectively, and may be placed, for example, at positions offset to the left and right at a rear end part of the vehicle (in a rear bumper).

Specifically, the rear side radar 20L detects an object that travels on the left rear side of the vehicle in the adjacent lane (left rear side vehicle), and the rear side radar 20R detects an object that travels on the right rear side of the vehicle in the adjacent lane (right rear side vehicle). Similar to the front side radars 10L and 10R, the rear side radars 20L and 20R may be configured with, for example, millimeter-wave radars, transmit radio waves in a 26 GHz millimeter wave band in a predetermined detectable range, and detect objects (the left rear side vehicle and/or the right rear side vehicle) by receiving reflected waves, respectively. Also, based on the received reflected waves, they may detect the relative position (distance and direction) and the relative speed of the detected objects with respect to the vehicle.

The rear side radars 20L and 20R are connected with the ECU 70 by an in-vehicle LAN or a direct line for communication, respectively, and output target object information (rear side target object information) to the ECU 70 that includes the relative position (distance and direction) and the relative speed of the objects detected on the left rear side and the right rear side of the vehicle.

Note that, similar to the front side radars 10L and 10R, the rear side radars 20L and 20R just need to be capable of detecting objects that exist on the rear side of the vehicle, and may be configured as, for example, laser radars.

Here, a method will be briefly described that detects objects traveling in the adjacent lane by the front side radars 10L and 10R and the rear side radars 20L and 20R.

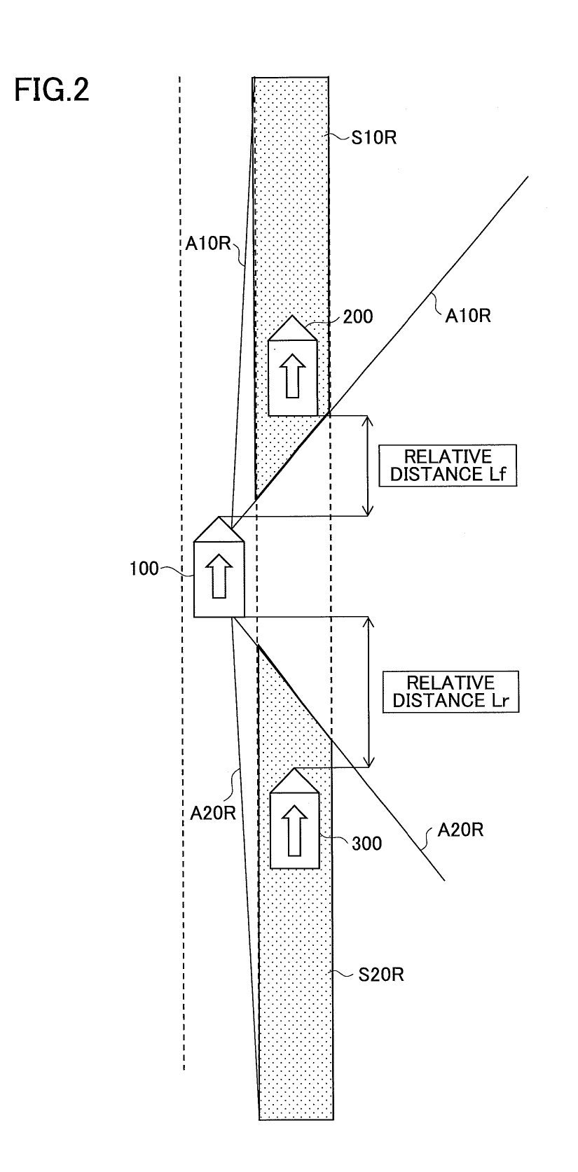

FIG. 2 is a diagram illustrating detection ranges of the front side radars 10L and 10R and the rear side radars 20L and 20R. Specifically, an example is illustrated where a vehicle 100 travels in a lane, and the front side radar 10R and the rear side radar 20R detect a front side vehicle 200 and a rear side vehicle 300 that travel in the right adjacent lane, respectively. Note that a detection method of objects that travel in the other adjacent lane by the front side radar 10L and the rear side radar 20L is the same as that is executed by the front side radar 10R and the rear side radar 20R, and the description is omitted.

Referring to FIG. 2, the front side radar 10R detects the front side vehicle 200 that travels on the front side in the adjacent lane, based on a reflected wave in a detection range S10R that corresponds to the adjacent lane within a detectable range A10R. Specifically, among objects detected in the detection range S10R, it recognizes an object that travels in virtually the same direction as the traveling direction of the vehicle 100, as the front side vehicle 200. Also, the rear side radar 20L detects the rear side vehicle 300 that travels on the rear side in the adjacent lane, based on a reflected wave in a detection range S20R that corresponds to the adjacent lane within a detectable range A20R. Specifically, similar to the front side radar 10R, among objects detected in the detection range S20R, it recognizes an object that travels in virtually the same direction as the traveling direction of the vehicle 100, as the rear side vehicle 300. Also, in FIG. 2, although the example is illustrated where the vehicle 100 travels on a straight line, if the vehicle travels on a curve, the curvature of the curve may be calculated based on the output (steering angle) of the steering sensor 50 to make the detection ranges S10R and S20R be directed in accordance with the curve.

Referring to FIG. 1 again, the wheel speed sensor 30 is a vehicle speed detection unit that detects the vehicle speed Vs of the vehicle. Specifically, it is provided for each wheel of the vehicle to detect the rotation speed of the wheel, from which the vehicle speed Vs of the vehicle can be calculated. The wheel speed sensor 30 is connected with the ECU 70 by an in-vehicle LAN or a direct line for communication, and outputs a signal corresponding to the vehicle speed Vs of the vehicle (vehicle speed signal) to the ECU 70.

The shift sensor 40 is a detection unit that detects a stage (shift position) of a transmission disposed between a source of driving force, such as an engine, and driving wheels. The shift sensor 40 is connected with the ECU 70 by an in-vehicle LAN or a direct line for communication, and outputs a signal corresponding to the shift position of the vehicle (shift position signal) to the ECU 70.

The steering sensor 50 is disposed at a steering shaft, which is a detection unit to detect the steering angle of steering by the driver. The steering sensor 50 is connected with the ECU 70 by an in-vehicle LAN or a direct line for communication, and outputs a signal corresponding to the steering angle of the vehicle (shift position signal) to the ECU 70.

The direction indicator (blinker switch) 60 is disposed close to the steering wheel, which is a switch to make a blinker lamp (not illustrated) illuminate (blink). The blinker lamp is disposed on the outside of the vehicle to indicate a lane change of the vehicle around the neighborhood of the vehicle. The direction indicator (blinker switch) 60 is connected with the ECU 70 by an in-vehicle LAN or a direct line for communication, and outputs an on/off signal to the ECU 70.

The ECU 70 is a control unit to control drive support operations relating to a lane change by the drive support apparatus 1. For example, it may be configured with a microcomputer to execute various control processes by running various programs stored in a ROM on a CPU. Specifically, it calculates time for a rear side vehicle, which travels in the adjacent lane, detected by the rear side object detection unit 20, to catch up with the rear end of the vehicle (TTC; Time To Collision), and if TTC becomes a threshold or less, issues an alarm to attract attention for a lane change. Also, it determines the threshold at this moment based on information and signals received from the front side object detection unit 10, the wheel speed sensor 30, and the shift sensor 40. Also, it determines whether acceleration is required for the lane change, and if determining that the acceleration is required, it indicates to the driver that the acceleration is required. Note that the alarm is issued via the outer mirror indicator 80, which will be described later, and indication of required acceleration is executed via the acceleration indicator 90, which will also be described later. Details of the above control process will also be described later.

The outer mirror indicator 80 is an alarm unit to attract attention of the driver when making a lane change. Specifically, it is disposed in an outer mirror placed at a position visible to the driver on the outside of the vehicle (for example, a front end part on the side surface of a front door), and may issue an alarm for the driver by illuminating (blinking) an indicator lamp, or by displaying arbitrary numbers, characters, figures, and the like. Note that the alarm unit to attract attention for making a lane change is not limited to the outer mirror indicator, but an arbitrary unit may be used as long as the driver can easily recognize an alarm. For example, an alarm may be issued by displaying numbers, characters, figures, and the like on a combination meter, or illuminating (blinking) an indicator lamp provided in the room of the vehicle. Also, an alarm sound generation device or the like may be used to issue an alarm by voice or the like.

The acceleration indicator 90 is an indication unit to indicate to the driver that acceleration is required for a lane change. An arbitrary unit may be used as long as the driver can easily recognize the indication. For example, it may be indicated by displaying numbers, characters, figures, and the like on a combination meter, or illuminating (blinking) an indicator lamp provided in the room of the vehicle. Also, an indicator sound generation device or the like may be used to issue an indication by voice or the like.

Next, drive support operations will be described that are executed for a specific lane change by the drive support apparatus 1.

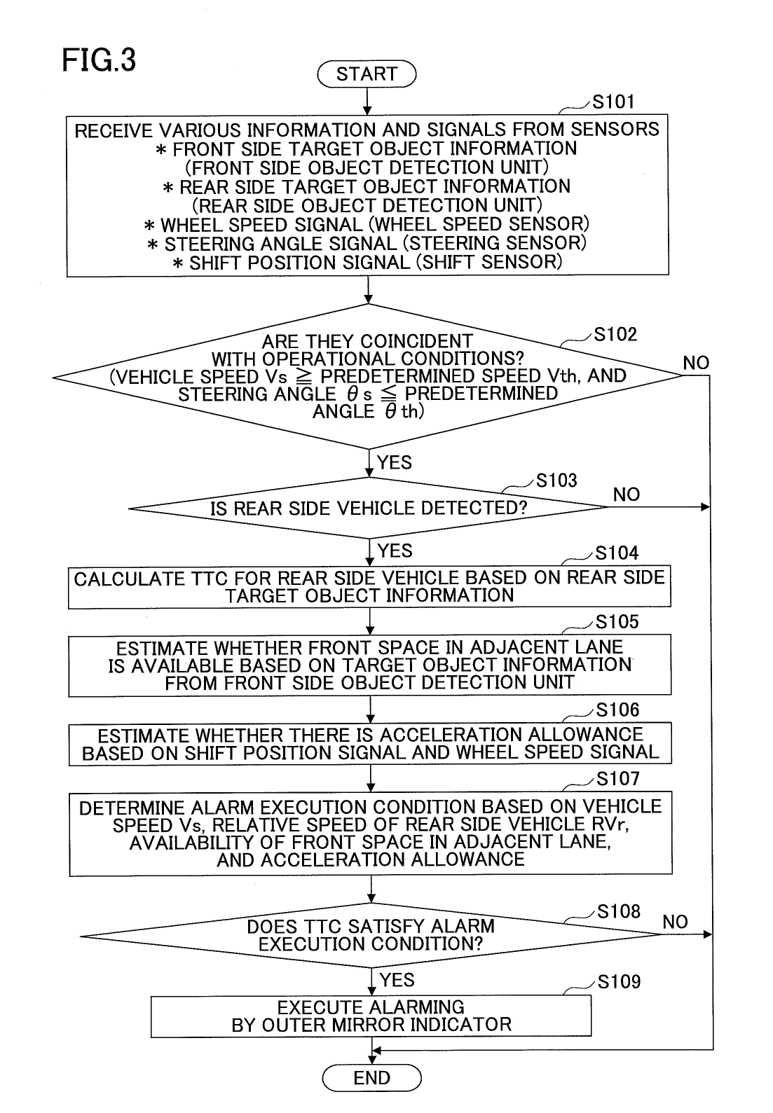

FIG. 3 is a flowchart illustrating drive support operations executed for a lane change by the drive support apparatus 1 according to the present embodiment, namely, process operations to issue an alarm based on TTC between the vehicle and a rear side vehicle. The process flow may be executed every predetermined time interval (for example, the update cycle of the front side radars 10L and 10R, and the rear side radars 20L and 20R, or the sampling cycle of the wheel speed sensor 30) after the ignition of the vehicle is turned on until it is turned off.

Referring to FIG. 3, at Step S101, the ECU 70 receives target object information (front side target object information and rear side target object information) from the front side object detection unit 10 and the rear side object detection unit 20. Also, it receives signals from the wheel speed sensor 30, the shift sensor 40, the steering sensor 50, and the direction indicator 60.

Next, at Step S102, the ECU 70 determines whether they are coincident with operational conditions of the process. Specifically, it determines whether the vehicle speed Vs is a predetermined speed Vth or greater, and the steering angle θs is a predetermined angle θth or less. This makes it possible to execute the drive support in an appropriate situation. Namely, if the vehicle speed Vs of the vehicle is a very low vehicle speed (if the vehicle speed Vs is lower than the predetermined speed Vth), it is less likely that the vehicle is traveling on a road where a lane change is required. Also, if the steering angle is considerably great (the steering angle θs is greater than the predetermined steering angle θth), the vehicle may be in a state of, for example, making a turnaround. If an alarm is issued in such a situation, it may give a driver a sense of discomfort. Therefore, by determining whether they are coincident with the operational conditions, the drive support can be executed appropriately. If they are coincident with the operational conditions, the process goes forward to Step S103, or if not coincident with the operational conditions, the current process ends.

Next, at Step S103, based on the rear side target object information, the ECU 70 determines whether an object (rear side vehicle) traveling on the rear side of the vehicle is detected in the adjacent lane. If the rear side vehicle is detected, the process goes forward to Step S104, or if the rear side vehicle is not detected, the current process ends.

Next, at Step S104, based on the rear side target object information, the ECU 70 calculates time for the rear side vehicle to catch up with the vehicle (TTC) in the adjacent lane. Note that the drive support apparatus 1 includes the rear side radars 20L and 20R. Therefore, if there are lanes adjacent left and right to the lane where the vehicle is traveling, it calculates TTC for both a rear side vehicle in the left adjacent lane, and a rear side vehicle in the right adjacent lane. In the following, for the sake of explanation, the vehicle is assumed to travel in the left side lane on a road having two lanes in each direction, and a rear side vehicle is assumed to be detected in the adjacent lane on the right side.

Specifically, based on the rear side target object information, the ECU 70 calculates the relative speed of the rear side vehicle with respect to the vehicle in the lane direction (referred to as “the relative speed of the rear side vehicle” below) RVr, and the distance between the vehicle and the rear side vehicle in the lane direction (referred to as “the relative distance of the rear side vehicle” below) Lr. Then, by dividing the relative distance of the rear side vehicle Lr by the relative speed RVr, TTC can be calculated. Note that as the rear side vehicle travels in virtually the same direction as the vehicle, the relative speed of the rear side vehicle RVr is nothing but the relative speed of the rear side vehicle with respect to the vehicle.

Next, at Step S105, the ECU 70 estimates whether a front space in the adjacent lane is available to which a lane change is to be made, based on the front side target object information. Specifically, it may estimate availability of a front space in the adjacent lane based on the distance between the front side vehicle and the vehicle in the lane direction (referred to as “the relative distance of the front side vehicle” below) Lf, and the relative speed of the front side vehicle with respect to the vehicle in the lane direction (referred to as “the relative speed of the front side vehicle” below) RVf, and the like. For example, it may estimate that a front space in the adjacent lane is available if the relative distance of the front side vehicle Lf is greater than or equal to a predetermined value, or it may estimate that a front space in the adjacent lane is available if the relative speed of the front side vehicle is a speed that makes the distance between the vehicles greater. Also, it may estimate that a front space in the adjacent lane is available if both conditions are satisfied. Note that the front side vehicle is a vehicle that travels in the same adjacent lane as the rear side vehicle, namely, travels in the adjacent lane adjacent on the right side of the vehicle. Also, as the front side vehicle travels in virtually the same direction as the vehicle, the relative speed of the front side vehicle RVf is nothing but the relative speed of the front side vehicle with respect to the vehicle.

Next, at Step S106, based on the shift position (shift position signal) and the vehicle speed Vs (vehicle speed signal) of the vehicle, the ECU 70 estimates whether there is allowance of time to sufficiently accelerate the vehicle for a lane change (acceleration allowance). Specifically, the ECU 70 may estimate whether there is acceleration allowance depending on an acceleration curve determined by the shift position (transmission stage) and the vehicle speed Vs of the vehicle.

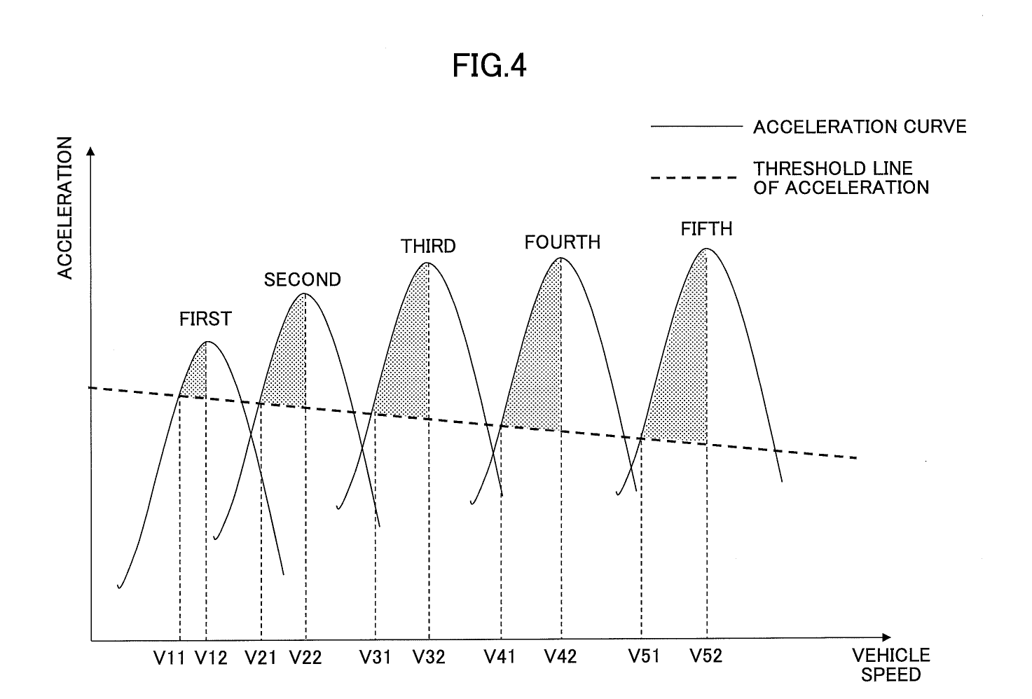

Here, an example of a method to estimate whether there is acceleration allowance will be described using FIG. 4. FIG. 4 illustrates acceleration curves (curves connecting maximum values of acceleration that can be generated depending on the vehicle speed Vs) for shift positions (transmission stages) on a map where the vertical axis represents the acceleration of the vehicle, and the horizontal axis represents the vehicle speed Vs of the vehicle. Note that, in the example illustrated in FIG. 4, the transmission of the vehicle is assumed to be a five-speed gearbox having transmission stages of the first gear to the fifth gear.

Referring to FIG. 4, on each acceleration curve, the acceleration rises while the vehicle speed Vs increases, and then, after reaching a maximal value of the acceleration, the acceleration falls while the vehicle speed Vs increases. Therefore, in a state where acceleration to be generated rises while the vehicle speed Vs increases, it can be considered that there is allowance of time for acceleration to a certain extent by an acceleration operation. Also, the absolute value of the acceleration required for a lane change needs to be considered. This is taken into account by, for example, generating the acceleration whose absolute value is above a threshold line of the acceleration in the figure. If such acceleration can be generated, it can be considered that there is allowance of time for acceleration to a certain extent by the acceleration operation. Thereupon, for example, at each of the transmission stages, if the vehicle is in a state where acceleration to be generated rises while the vehicle speed Vs increases, and the acceleration to be generated is greater than the predetermined threshold, it may be determined that there is acceleration allowance. Specifically, if the shift position is at the first gear and the vehicle speed Vs is between V11 to V12, it may be determined that there is acceleration allowance. Also, similarly, if the shift position is at the second gear and the vehicle speed Vs is between V21 to V22, the shift position is at the third gear and the vehicle speed Vs is between V31 to V32, the shift position is at the fourth gear and the vehicle speed Vs is between V41 to V42, or the shift position is at the fifth gear and the vehicle speed Vs is between V51 to V52, it may be determined that there is acceleration allowance. Note that the threshold is set to become lower while the vehicle speed Vs of the vehicle increases in the figure. This is because greater acceleration is required for a lane change when the vehicle speed Vs is lower. For example, to increase the vehicle speed Vs by 10 km/h, greater acceleration is required for accelerating the vehicle speed Vs from 30 km/h to 40 km/h than for accelerating the vehicle speed Vs from 100 km/h to 110 km/h. Also, although the threshold is set to become lower continuously while the vehicle speed Vs of the vehicle increases, it may be set to become lower stepwise.

Note that Steps S104 to S106 described above may be executed in interchanged order, or may be executed concurrently.

Next, at Step S107, the ECU 70 determines an alarm execution condition (TTC condition), based on the vehicle speed Vs of the vehicle, the relative speed of the rear side vehicle RVr, the availability of a front space in the adjacent lane, and the acceleration allowance of the vehicle. Specifically, based on the vehicle speed Vs, the relative speed of the rear side vehicle RVr, the availability of a front space in the adjacent lane, and the acceleration allowance of the vehicle, an alarm execution condition map may be stored in a ROM in the ECU 70 beforehand, to determine an alarm start timing (TTC threshold), with which the threshold is determined.

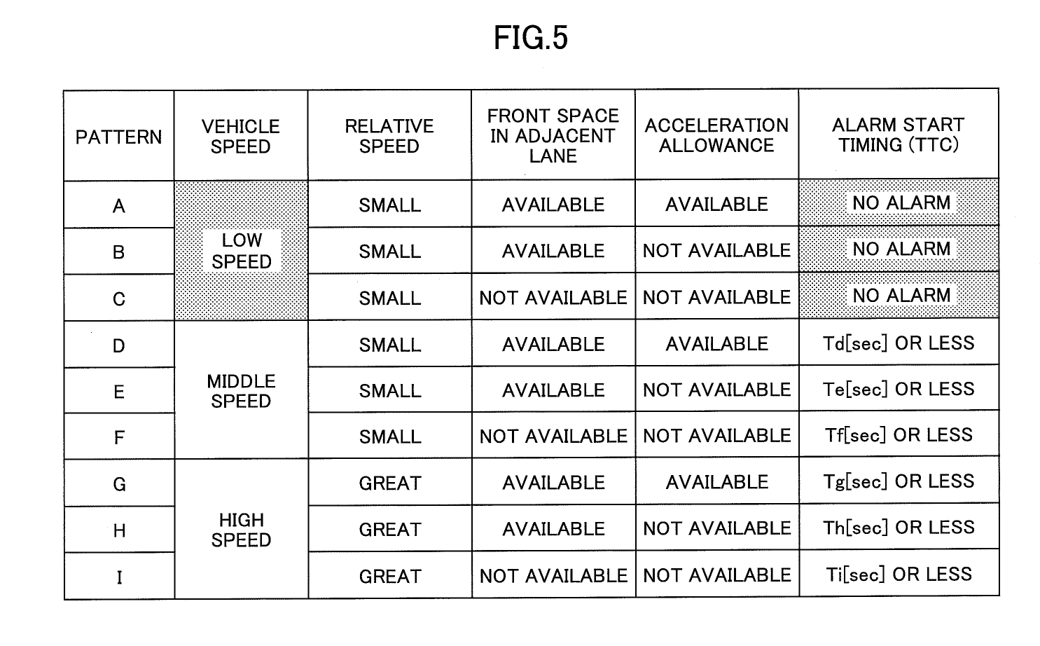

Here, the alarm execution condition map will be described using FIG. 5. FIG. 5 is a diagram illustrating an example of the alarm execution condition map. The alarm execution condition map includes columns for, from the left, the vehicle speed Vs of the vehicle, the relative speed of the rear side object RVr, the front space in the adjacent lane, the acceleration allowance, and the alarm start timing (TTC threshold). At each of the rows, the alarm start timing (TTC threshold) is determined by a combination of the vehicle speed Vs of the vehicle, the relative speed of the rear side vehicle RVr, the front space in the adjacent lane, and the acceleration allowance. Nine combinations, or patterns A to I, are illustrated that are combinations of the vehicle speed Vs of the vehicle, the relative speed of the rear side vehicle RVr, the front space in the adjacent lane, and the acceleration allowance. Note that patterns A to I do not represent all possible combinations of the vehicle speed Vs of the vehicle, the relative speed of the rear side vehicle RVr, the front space in the adjacent lane, and the acceleration allowance, but are an example of a part of all combinations for explanation. Also, “LOW SPEED” in the column of the vehicle speed Vs of the vehicle means, for example, Vs<20 km/h; “MIDDLE SPEED” means, for example, 20 km/h≦Vs≦80 km/h; and “HIGH SPEED” means, for example, Vs≧80 km/h. Also, “SMALL” in the column of the relative speed of the rear side vehicle RVr means, for example, RVr<20 km/h; and “GREAT” means, for example, RVr≧20 km/h. Also, thresholds Ta to Ti for patterns A to I are specified to satisfy a mutual relationship where Td<Te<Tf, Tg<Th<Ti, Td<Tg, Te<Th, and Tf<Ti.

If the acceleration allowance is NOT AVAILABLE, a lane change cannot be made while accelerating the vehicle. In this case, the alarm start timing may be set earlier than when the acceleration allowance is AVAILABLE (TTC threshold is set greater). Therefore, referring to FIG. 5, when the vehicle speed Vs of the vehicle is MIDDLE SPEED, the alarm start timing of pattern E having acceleration allowance not available is set earlier than that of pattern D having acceleration allowance AVAILABLE (Td<Te). Also, when the vehicle travels at a HIGH SPEED, the relationship between patterns G and H (Tg<Th) is the same as the case of MIDDLE SPEED of the vehicle speed Vs of the vehicle.

Also, if a front space in the adjacent lane is NOT AVAILABLE, the space between a front side vehicle and a rear side vehicle in the destination lane is narrower than when a front space in the adjacent lane is AVAILABLE. In this case, the alarm start timing may be set earlier (TTC threshold is set greater). Therefore, referring to FIG. 5, when the vehicle speed Vs of the vehicle is MIDDLE SPEED, the alarm start timing is set earlier for pattern F having a front space in the adjacent lane NOT AVAILABLE than for pattern E having a front space in the adjacent lane AVAILABLE (Te<Tf). Also, when the vehicle speed Vs of the vehicle is HIGH SPEED, the relationship between patterns H and I (Th<Ti) is similar to the case of MIDDLE SPEED of the vehicle speed Vs of the vehicle.

Also, if the relative speed of the rear side vehicle RVr is greater, to prevent a rear side vehicle from being forced to decelerate after a lane change of the vehicle, the vehicle needs to accelerate more than when the relative speed of the rear side vehicle RVr is smaller, to make the lane change in front of the rear side vehicle. Therefore, if the relative speed RVr is greater, the alarm start timing may be set earlier (TTC threshold is set greater) than when the relative speed RVr is smaller. Therefore, referring to FIG. 5, for patterns where the front space in the adjacent lane is AVAILABLE and the acceleration allowance is AVAILABLE, the alarm start timing of pattern G having a greater relative speed of the rear side vehicle RVr is set earlier than that of pattern D having a smaller relative speed of the rear side vehicle RVr (Td<Tg). Also, similarly, for patterns where the front space in the adjacent lane is AVAILABLE and the acceleration allowance is NOT AVAILABLE, the alarm start timing of pattern H having a greater relative speed of the rear side vehicle RVr is set earlier than that of pattern E having a smaller relative speed of the rear side vehicle RVr (Te<Th). Also, similarly, for patterns where the front space in the adjacent lane is NOT AVAILABLE and the acceleration allowance is NOT AVAILABLE, the alarm start timing of pattern I having a greater relative speed of the rear side vehicle RVr is set earlier than that of pattern F having a smaller relative speed of the rear side vehicle RVr (Tf<Ti).

Note that patterns D to F and patterns G to I are different with respect to the vehicle speed Vs of the vehicle, it is assumed that the alarm start timing is not changed due to an influence of the vehicle speed Vs of the vehicle. Namely, in patterns G to I, if the relative speed of the rear side vehicle RVr is changed from GREAT to SMALL, the alarm start timings are the same as in patterns D to F, respectively. Also, in patterns G to I, if the vehicle speed Vs of the vehicle is changed from HIGH SPEED to MIDDLE SPEED, the alarm start timings are not changed.

Also, if the vehicle speed Vs of the vehicle is LOW SPEED, the vehicles tend to travel in a state where they are very close to each other. In such a case, if an alarm is set to be issued when TTC is the threshold or less, there is a likelihood of always being in an alarming state. Therefore, if an alarm is issued based on TTC, it may give the driver a sense of discomfort. This point is taken into account in FIG. 5 so that if the vehicle speed Vs of the vehicle is LOW SPEED, no alarm is issued regardless of the relative speed of the rear side vehicle RVr, the front space in the adjacent lane, and the acceleration allowance. Note that if the vehicle speed Vs of the vehicle is LOW SPEED, the TTC threshold may be set smaller than when the vehicle speed Vs of the vehicle is MIDDLE SPEED or HIGH SPEED, to avoid an always-alarming state. Also, in this case, the relationship between the thresholds for patterns A to C may be similarly set as the relationship between the thresholds for patterns G to I, or patterns D to F as described above.

In this way, the alarm execution condition (TTC threshold) may be determined depending of the vehicle speed Vs of the vehicle, the relative speed of the rear side vehicle RVr, the front space in the adjacent lane, and the acceleration allowance, using the alarm execution condition map set as above.

Referring to FIG. 3 again, next, at Step S108, the ECU 70 determines whether TTC calculated at Step S104 satisfies a determined alarm execution condition, namely, whether TTC is less than or equal to the threshold determined at Step S107. If TTC is less than or equal to the threshold, the process goes forward to Step S109, or if TTC is not less than or equal to the threshold (TTC is greater than the threshold), the current process ends.

Next, at Step S109, an alarm is issued by the outer mirror indicator 80, and the current process ends. Specifically, the ECU 70 outputs an operation signal to the outer mirror indicator 80, and in response to receiving the operation signal, the outer mirror indicator 80 may display numbers, characters, figures, and the like on the combination meter, or may illuminate (blink) the indicator lamp, to issue the alarm. Note that if the direction indicator 60 is turned on, namely, if an on signal is output from the direction indicator 60 to the ECU 70, the strength of the alarm by the outer mirror indicator 80 may be raised to make the alarm more recognizable by the driver. For example, if the alarm is issued by the indicator lamp, the strength of the alarm may be raised by changing an illuminating state to a blinking state. Also, if the alarm is issued by displaying numbers, characters, figures, and the like, the strength of the alarm may be raised by changing the display color to red. With such an alarm, the driver can easily recognize the alarm in a situation where an actual lane change is to be made, confirm the state around the vehicle (rear side vehicles and front side vehicles), and safely perform the lane change.

As described above, the drive support apparatus 1 according to the present embodiment determines a TTC threshold (alarm start timing) based on a front side vehicle that travels in the same lane as a rear side vehicle that travels in the adjacent lane to the vehicle. Specifically, the TTC threshold may be determined based on availability of a front space in the adjacent lane. In this case, the TTC threshold may be set greater for a case where a front space in the adjacent lane is not available than in a case where a front space in the adjacent lane is available. More specifically, the TTC threshold may be determined based on a positional relationship between the vehicle and the front side vehicle (for example, whether the relative distance of the front side vehicle Lf is greater than or equal to a predetermined value). Also, the TTC threshold may be determined based on the relative speed of the front side vehicle RVf (for example, whether the relative speed of the front side vehicle RVf is a speed that makes the distance between the vehicles become greater). Thus, the alarm start timing is determined depending on the size of the space in the destination lane that is affected by the existence of the front side vehicle, which makes it possible to issue an alarm at an appropriate alarm timing. For example, if there is a sufficient space in front in the destination lane, an unnecessary alarm can be avoided, such as issuing an early alarm. Also, in an actual lane change, the driver pays attention to the relationship with a front side vehicle while driving. Therefore, by determining the TTC threshold based on the front side vehicle, an alarm can be issued at an appropriate alarm timing that is suited to the sense of the driver.

Note that if adjacent lanes exist on both sides, similarly to the above described TTC threshold relating to the rear side vehicle detected in the right side adjacent lane, a TTC threshold relating to a rear side vehicle detected in the left side adjacent lane may be determined based on a front side vehicle traveling in the left side adjacent lane.

Also, the drive support apparatus 1 may determine the TTC threshold based on whether the vehicle has sufficient allowance of time to accelerate (acceleration allowance) for a lane change. Specifically, it may determine the TTC threshold (by determining whether there is acceleration allowance), depending on the vehicle speed Vs of the vehicle and the shift position of the vehicle (transmission stage). In this case, the TTC threshold may be set greater for a case where the acceleration allowance is not available than in a case where the acceleration allowance is available. Namely, if there is a sufficient allowance of time to accelerate for a lane change, the lane change can be made smoothly in front of the rear side vehicle by the acceleration, and the alarm start timing may be set later than in a case where the acceleration allowance is less. Conversely, if allowance of time is not sufficient to accelerate for the lane change, the lane change may not be made smoothly in front of the rear side vehicle by the acceleration, and the alarm start timing may be set earlier than in a case where the acceleration allowance is greater. Thus, it is possible to issue an alarm at an appropriate alarm timing depending on a state of the vehicle (acceleration allowance).

Also, the drive support apparatus 1 may determine the TTC threshold based on the relative speed of the rear side vehicle RVr. Specifically, if the relative speed of the rear side vehicle RVr is greater than or equal to a predetermined value, the TTC threshold may be set greater (alarm start timing is set earlier). This causes an alarm to be issued earlier to prevent the rear side vehicle from being forced to decelerate after the lane change of the vehicle, and a smooth lane change can be performed.

Next, operations will be described that are executed by the drive support apparatus 1 to indicate to the driver whether the vehicle needs to accelerate for a lane change.

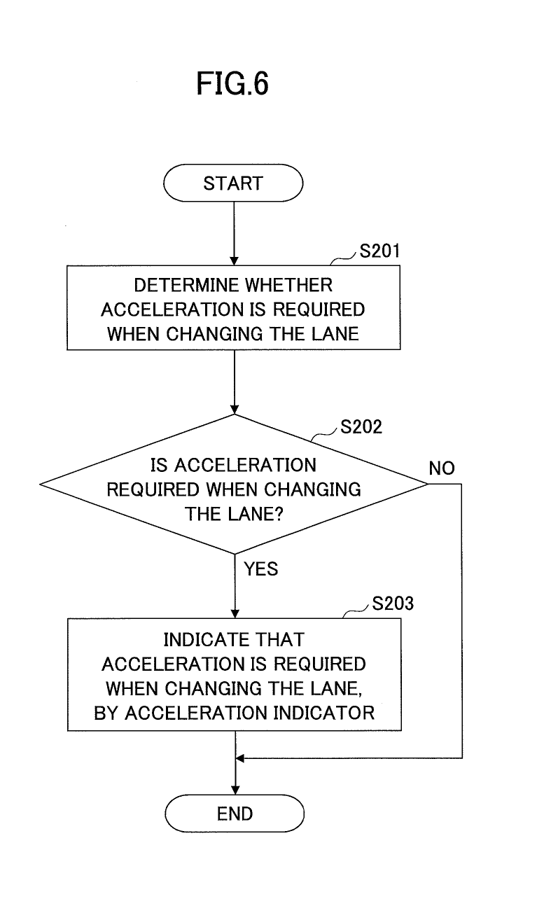

FIG. 6 is a flowchart illustrating an example of drive support operations relating to a lane change executed by the drive support apparatus 1 (ECU 70) according to the present embodiment, namely, process steps to indicate to the driver whether the vehicle needs to accelerate for making a lane change. The process flow may be executed concurrently with the process flow illustrated in FIG. 3. Namely, it may be executed every predetermined time interval (for example, the update cycle of the front side radars 10L and 10R, and the rear side radars 20L and 20R, or the sampling cycle of the wheel speed sensor 30) after the ignition of the vehicle is turned on until it is turned off.

Referring to FIG. 6, at Step S201, the ECU 70 determines whether acceleration is required when making a lane change.

Next, at Step S202, based on the determination at Step S201, the ECU 70 determines whether acceleration is required when making the lane change. If acceleration is required when making the lane change, the process goes forward to Step S203, or if acceleration is not required when making the lane change, the current process ends.

Next, at Step S203, that acceleration is required when making the lane change is indicated by the acceleration indicator 90, and the current process ends. Specifically, the ECU 70 outputs an operation signal to the acceleration indicator 90, and in response to receiving the operation signal, the acceleration indicator 90 may display numbers, characters, figures, and the like on the combination meter, or may illuminate (blink) the indicator lamp, to execute the indication. Note that if the direction indicator 60 is turned on, namely, if an on signal is output from the direction indicator 60 to the ECU 70, the strength of the alarm by the acceleration indicator 90 may be raised to make the indication more recognizable by the driver. For example, if it is indicated by the indicator lamp, the strength of the alarm may be raised by changing an illuminating state to a blinking state. Also, if it is indicated by displaying numbers, characters, figures, and the like, the strength of the indication may be raised by changing the display color to red. With such an indication, the driver can easily recognize that acceleration is required in a situation where an actual lane change is to be made, and safely perform the lane change.

Here, specific methods will be described that determine whether acceleration is required for a lane change.

First, an example of one of the determination methods will be described that determines whether acceleration is required for a lane change. The example is based on a state of the vehicle (such as acceleration possibly generated by the vehicle).

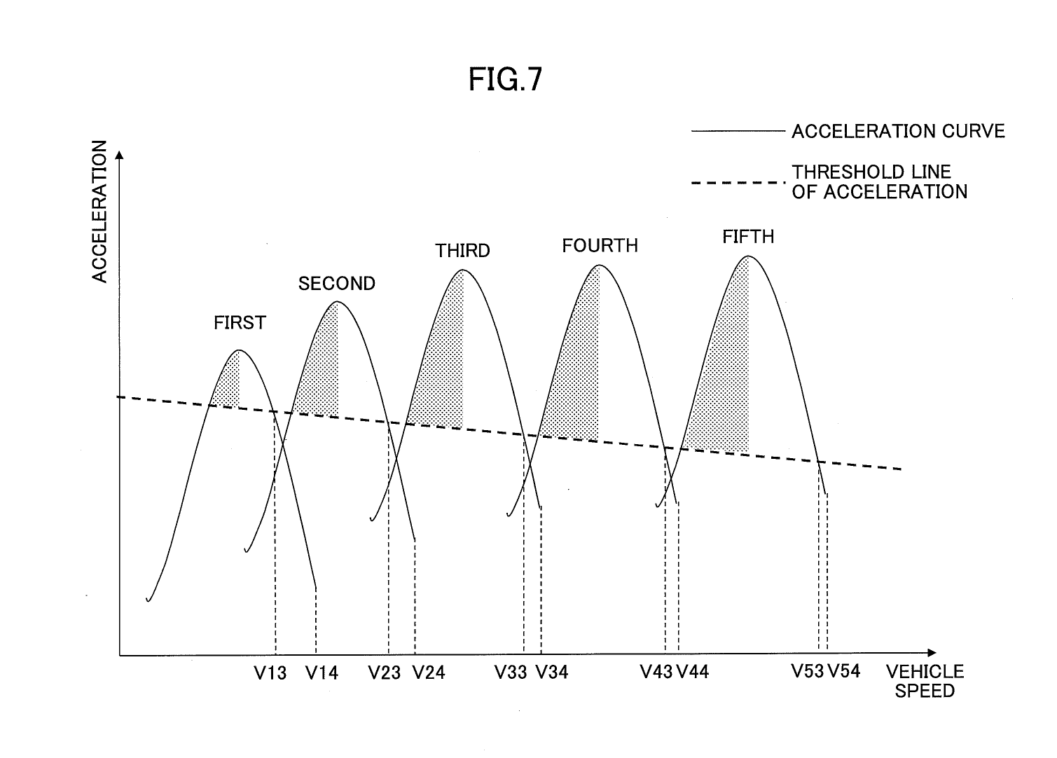

FIG. 7 is a diagram illustrating the example of the method of determining whether the vehicle needs to accelerate for making a lane change. Similar to FIG. 4, FIG. 7 illustrates acceleration curves (curves connecting maximum values of acceleration that can be generated depending on the vehicle speed Vs) for shift positions (transmission stages) on a map where the vertical axis represents the acceleration of the vehicle and the horizontal axis represents the vehicle speed Vs of the vehicle. Also, a threshold line designated by a dotted line is the same as in FIG. 4. Note that, in the example illustrated in FIG. 7, the transmission of the vehicle is assumed to be a five-speed gearbox having transmission stages of the first gear to the fifth gear.

Referring to FIG. 7, on each acceleration curve, the acceleration rises while the vehicle speed Vs increases, and then, after reaching a maximal value of the acceleration, the acceleration falls while the vehicle speed Vs increases. Therefore, in a state where acceleration to be generated falls while the vehicle speed Vs increases, acceleration for a lane change cannot be made unless the driver performs an active (early) acceleration operation. Also, if only low acceleration can be generated below the threshold line of acceleration in the figure, acceleration for a lane change cannot be made unless the driver performs an active (early) acceleration operation. Thereupon, for example, at each of the transmission stages, if the vehicle is in a state where acceleration to be generated falls while the vehicle speed Vs increases, and the acceleration to be generated is less than the predetermined threshold, it may be determined that acceleration is required for a lane change. Specifically, if the shift position is at the first gear and the vehicle speed Vs is between V13 to V14, it may be determined that acceleration is required for a lane change. Also, similarly, if the shift position is at the second gear and the vehicle speed Vs is between V23 to V24, the shift position is at the third gear and the vehicle speed Vs is between V33 to V34, the shift position is at the fourth gear and the vehicle speed Vs is between V43 to V44, or the shift position is at the fifth gear and the vehicle speed Vs is between V53 to V54, it may be determined that acceleration is required for a lane change.

Next, another example of the determination methods will be described that determines whether acceleration is required for a lane change. The example is based on the relationship between the vehicle and the rear side vehicle.

If the relative speed of the rear side vehicle RVr is comparatively great (relative speed RVr is greater than or equal to a predetermined value, for example, 20 km/h), to prevent the rear side vehicle from being forced to decelerate after a lane change of the vehicle, the vehicle needs to accelerate to a certain extent before the lane change. Therefore, if the relative speed of the rear side vehicle RVr is comparatively great, it may be determined that acceleration is required for a lane change.

Next, yet another example of the determination methods will be described that determines whether acceleration is required for a lane change. The example is based on the relationship between the vehicle and the front side vehicle.

If a front space in the adjacent lane is available as described above, a lane change can be made while accelerating, and hence, a smooth lane change can be performed. Therefore, if a front space in the adjacent lane is available, it may be determined that acceleration is required for a lane change.

Thus, the drive support apparatus 1 determines whether acceleration is required for a lane change, and if required, indicates to the driver that acceleration is required. Therefore, the driver can perform a smooth lane change.

Also, as described above, the drive support apparatus 1 according to the present embodiment determines an alarm timing based on availability of acceleration allowance for the vehicle. Namely, since an alarm timing may be determined assuming that the vehicle accelerates when changing a lane, indication is done by the acceleration indicator to complement the alarm.

Although the embodiments of the present invention have been described in detail, it should be understood that the various changes, substitutions, and alterations could be made hereto without departing from the spirit and scope of the invention.

The present application is based on Japanese Priority Application No. 2014-011681, filed on Jan. 24, 2014, the entire contents of which are hereby incorporated by reference.

What is claimed is:

1. A drive support apparatus including
a rear side object detection unit configured to detect a relative position and a relative speed of a rear side object with respect to a vehicle having the drive support apparatus installed, the rear side object traveling in an adjacent lane adjacent to a traveling lane of the vehicle, and being on a rear side of the vehicle,
a calculation unit configured to calculate time for the rear side object to catch up with a rear end of the vehicle in the adjacent lane, based on the relative position and the relative speed, and
an alarm unit configured to issue an alarm to a driver of the vehicle if the time to catch up is less than or equal to a threshold,
the drive support apparatus comprising:
a front side object detection unit configured to detect a front side object traveling on a front side of the vehicle in the adjacent lane; and
a threshold determination unit configured to determine the threshold based on the front side object.

2. The drive support apparatus as claimed in claim 1, wherein the threshold determination unit determines the threshold, at least based on a positional relationship between the vehicle and the front side object.

3. The drive support apparatus as claimed in claim 1, wherein the threshold determination unit determines the threshold, at least based on a relative speed of the front side object with respect to the vehicle.

4. The drive support apparatus as claimed in claim 1, wherein the threshold determination unit determines the threshold, based on a vehicle speed and a shift position of the vehicle.

5. The drive support apparatus as claimed in claim 1, wherein the threshold determination unit determines the threshold, based on the relative speed detected by the rear side object detection unit.

6. The drive support apparatus as claimed in claim 1, further comprising:
a determination unit configured to determine whether the vehicle needs to accelerate for making a lane change into the adjacent lane, based on a predetermined requirement; and
an indication unit configured to indicate to the driver that the vehicle needs to accelerate for making the lane change into the adjacent lane if the determination unit determines that acceleration is required.

7. The drive support apparatus as claimed in claim 6, wherein the determination unit determines whether the vehicle needs to accelerate for making the lane change into the adjacent lane, based on a vehicle speed and a shift position of the vehicle.

8. The drive support apparatus as claimed in claim 6, wherein the determination unit determines whether the vehicle needs to accelerate for making the lane change into the adjacent lane, based on the relative speed detected by the rear side vehicle detection unit.

9. The drive support apparatus as claimed in claim 6, wherein the determination unit determines whether the vehicle needs to accelerate for making the lane change into the adjacent lane, based on a positional relationship between the vehicle and the front side object.
